(19) United States
(12) Patent Application Publication
(10) Pub. No.: US 2007/0078765 A1
(43) Pub. Date: Apr. 5, 2007

(54) Automated maintenance contracts system and method

(76) Inventor: Corey L. Holton, Portland, OR (US)

Correspondence Address: GRAYBEAL, JACKSON, HALEY LLP, 155 - 108TH AVENUE NE, SUITE 350, BELLEVUE, WA, 98004-5901, US

(21) Appl. No.: 11/522,065

(22) Filed: Sep. 15, 2006

Related U.S. Application Data
(60) Provisional application No. 60/718,177, filed on Sep. 15, 2005.

(51) Int. Cl. G06Q 40/00

(52) U.S. Cl. 705/40

(57) ABSTRACT

A program tracks all aspects of reoccurring maintenance contracts and automatically creates the monthly invoice for the customer. The program tracks Customer Information, the contract type, the work location, what equipment to service, what work to perform, the beginning and end of the contract period, the days to perform work, how often the service is performed, the personnel and/or a vehicle required to perform the work, and the materials and labor expended.

### PRIORITY CLAIM

This application claims priority from U.S. Provisional Patent Application No. 60/718,177, filed Sep. 15, 2005, which is incorporated herein by reference.

### TECHNICAL FIELD

The present invention relates generally to computer programs, and more specifically to business computer programs for performing various tasks associated with running a business.

### BACKGROUND OF THE INVENTION

A business that maintains equipment for a customer according to an agreement has a need to record details about the agreement or contract for future reference so they can fulfill their responsibilities. A business may have hundreds of such contracts. The effort required to perform the business functions of inventory management, resource planning, and order entry for each contract can be very involved, repetitive, and time consuming. A business must maintain a detailed record of each contract including information such as, Customer Information, the contract type, the work location, what equipment to service, what work to perform, the beginning and end of the contract period, the days to perform work, how often the service is performed, the personnel and/or a vehicle required to perform the work, and the materials and labor expended on a recurring basis. Maintaining this information on multiple contracts can be very difficult and time consuming. Once a company details the contracts, they then need to invoice the customer daily, weekly, monthly or per task by creating a work order for services rendered.

There is a need for a tracking system that manages all aspects of a maintenance contact and automatically creates corresponding customer invoices. Automating this process can save a business a substantial amount of time and help ensure that services are rendered promptly and correctly.

### SUMMARY OF THE INVENTION

According to one aspect of the present invention, a program tracks all aspects of reoccurring maintenance contracts and automatically creates the monthly invoice for the customer. The program tracks Customer Information, the contract type, the work location, what equipment to service, what work to perform, the beginning and end of the contract period, the days to perform work, how often the service is performed, the personnel and/or a vehicle required to perform the work, and the materials and labor expended.

### BRIEF DESCRIPTION OF THE DRAWINGS

FIG. 1 is a functional block diagram of a computer system including processing circuitry for executing a business management computer program including a maintenance contracts component according to one embodiment of the present invention.

FIG. 2 describes a process executed by the maintenance contracts component of FIG. 1 according to one embodiment of the present invention.

FIGS. 3-13 are screens rendered by the maintenance contracts component of the business management computer program during execution of the program according to one embodiment of the present invention

### DETAILED DESCRIPTION OF PREFERRED EMBODIMENTS

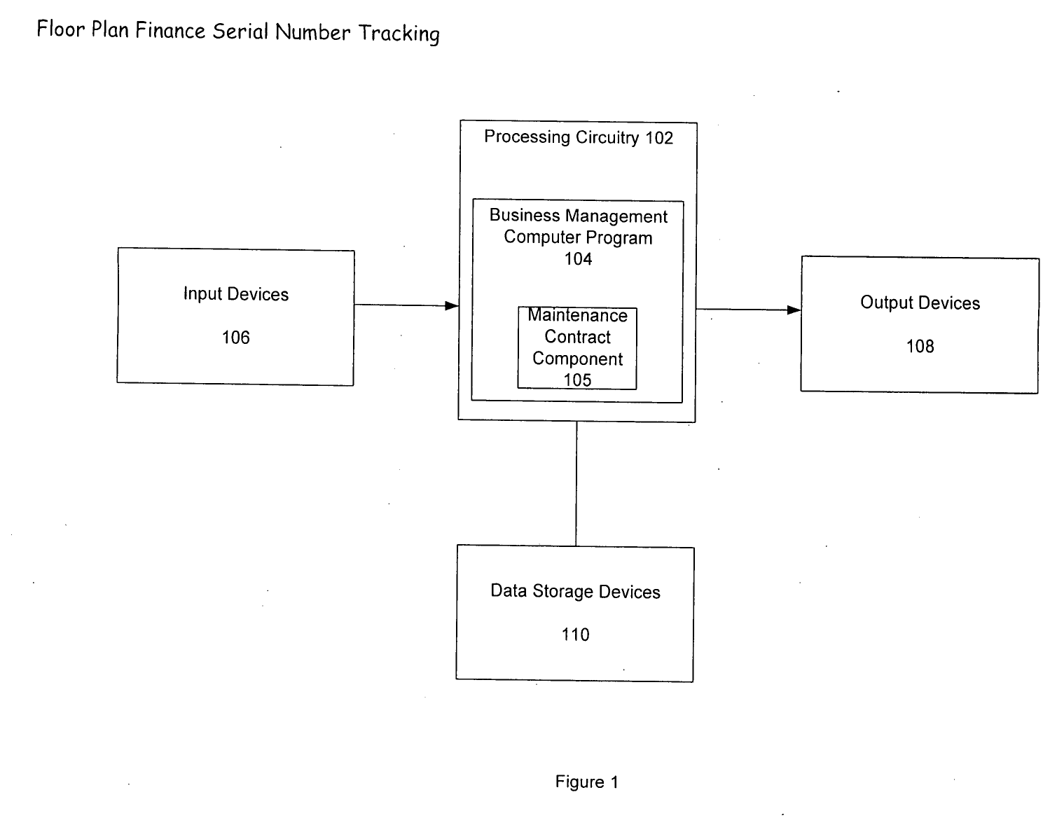

FIG. 1 is a functional block diagram of a computer system 100 including processing circuitry 102 for executing a business management computer program 104 including a maintenance contracts component 105 according to one embodiment of the present invention. The computer system 100 includes one or more input devices 106, such as a keyboard or a mouse, coupled to the processing circuitry 102 to allow an operator to interface with the computer system. Typically, the computer system 100 also includes one or more output devices 108 coupled to the processing circuitry 102, such output devices typically including a printer and a video terminal. One or more data storage devices 110 are also typically coupled to the processing circuitry 102 to store data or retrieve data from external storage media (not shown). Examples of typical storage devices 110 include hard and floppy disks, tape cassettes, compact disk read-only (CD-ROMs) and compact disk read-write (CD-RW) memories, and digital video disks (DVDs).

In the present description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described below do not limit the scope of the present invention, and will also understand that various modifications, equivalents, and combinations of the disclosed embodiments and components of such embodiments are within the scope of the present invention. Embodiments including fewer than all the components of any of the respective described embodiments may also be within the scope of the present invention although not expressly described in detail below. Finally, the operation of well known components and/or processes has not been shown or described in detail to avoid unnecessarily obscuring the present invention.

An integrated system for providing comprehensive functionality for all business processes from the generation of leads via marketing efforts through the preparation of financial statements containing entries for sales of products or services to such leads is set forth in U.S. patent application Ser. No. 11/185,103 entitled LEAD-TO-INCOME STATEMENT METHOD AND SYSTEM, which was filed on Jul. 19, 2005 and which is incorporated herein by reference. The business management computer program 104 and maintenance contracts component 105 are part of the integrated system or program described in this application in one embodiment of the present invention.

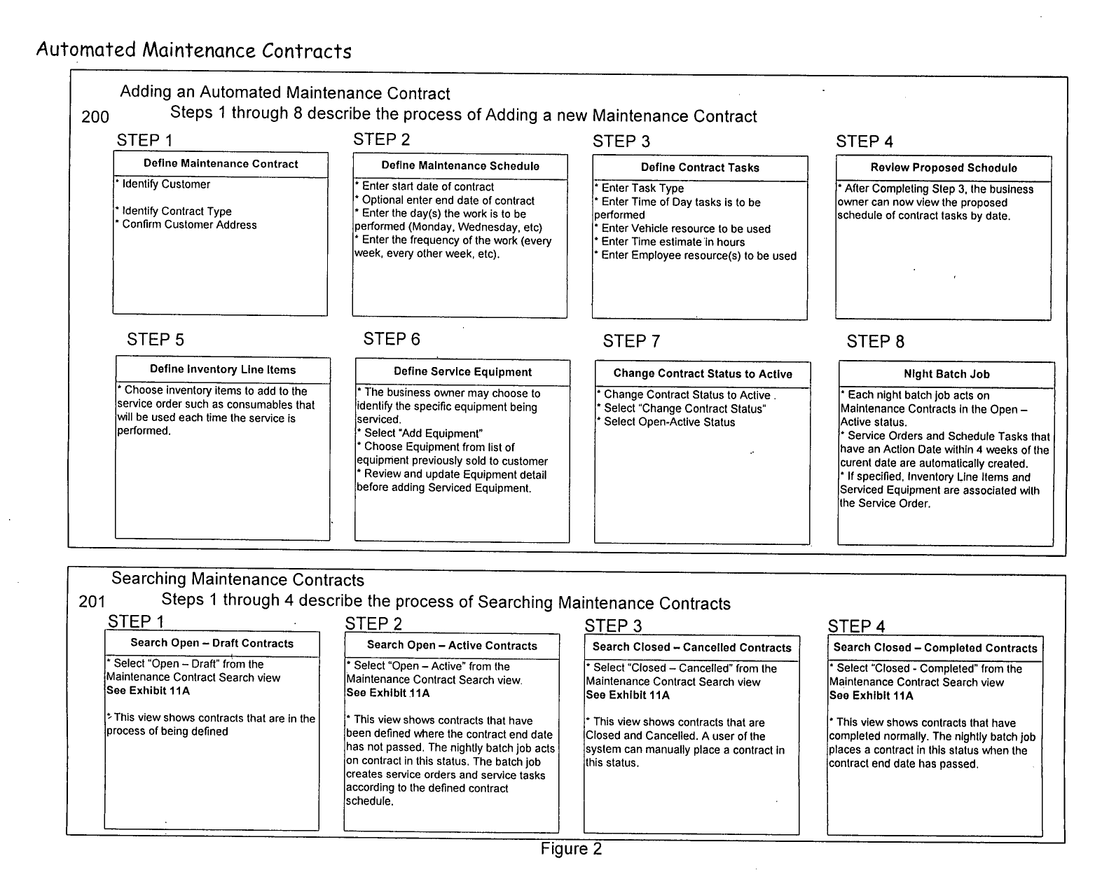

One process by which the maintenance contracts component 105 creates and monitors an automated maintenance contract is shown in FIG. 2. Steps 1-8 in the upper portion of FIG. 2 illustrate a process 200 through which the maintenance contracts component 105 generates a new maintenance contract. Steps 1-4 in the lower portion of FIG. 2 illustrates a process 201 through which the maintenance contracts component searches or monitors existing maintenance contracts that have already been created through the process 200.

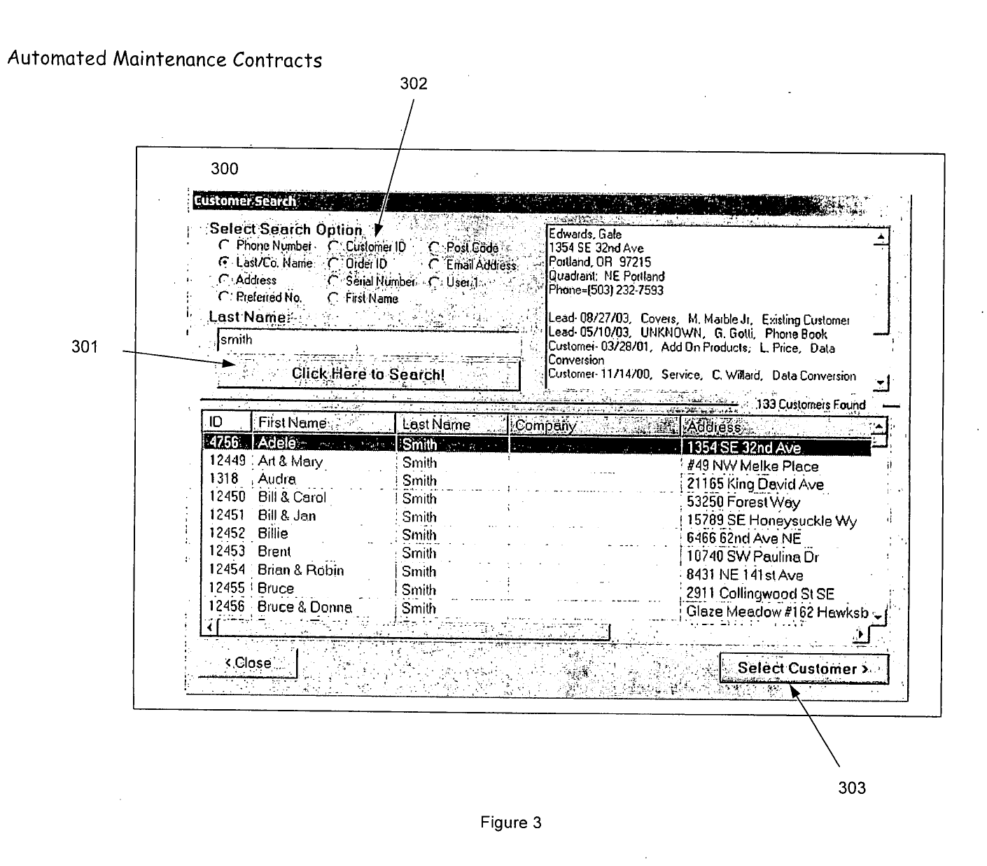

FIGS. 3-13 are screen shots of screens rendered by the maintenance contracts component 105 during execution of the processes 200 and 201 of FIG. 2 and which will now be described in more detail. Note in these figures that various fields are shown and that when referring to these fields in the following description the term “field” may be omitted for the sake of brevity. First, a customer needs to be identified using a customer search screen 300 as shown in FIG. 3. Through the upper left portion of the screen 300, a user of the program 104 (FIG. 1) can enter a search query to search for a desired customer or lead in a database (not shown) generated by the program. Customers and leads found in the database for a given search query are shown in the lower portion of the search screen 300. Searches of the database can be done using a number of search criteria 302 including Phone Number, Last Name/Company Name, Address, Preferred customer number, Customer ID, Order ID, Serial Number, First Name, Postal Code, Email Address, or by a user defined variable. Once the desired search criteria has been selected, a Click Here to Search Button 301 is used to display the query results in the lower half of the customer search screen 300. To select a customer, a user of the program clicks on the desired customer and then clicks on a Select Customer Button 303.

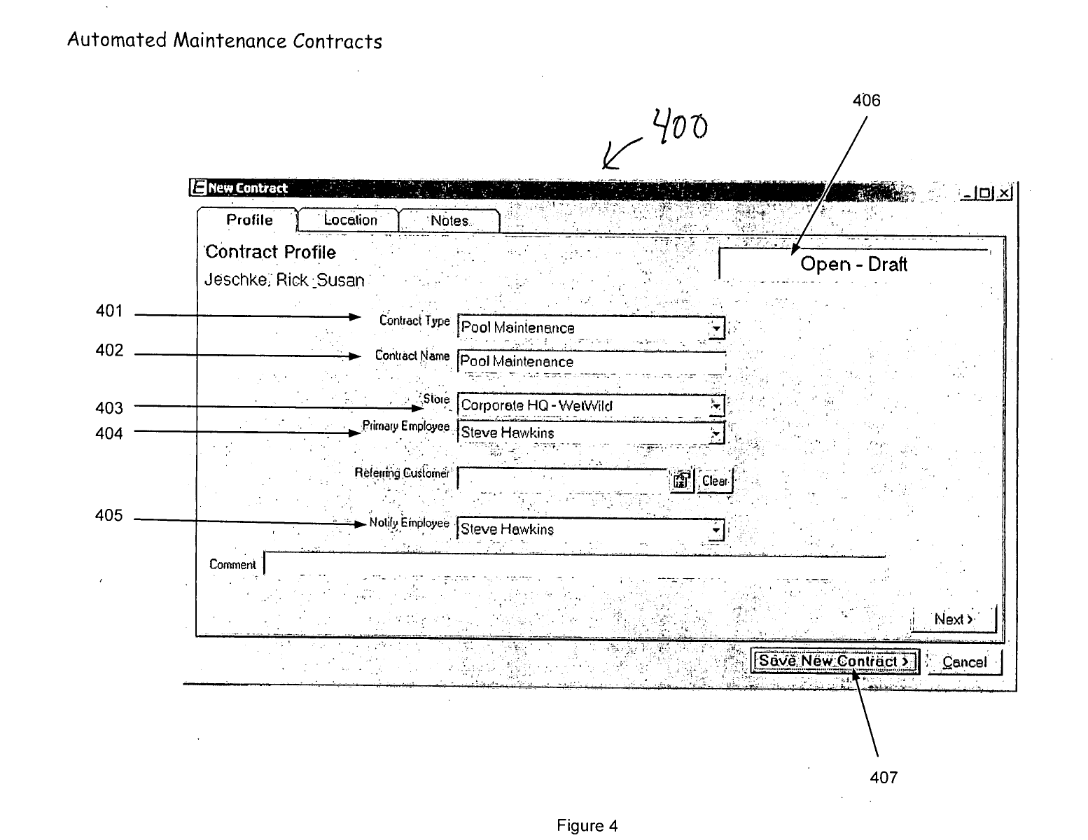

Once a customer is selected, a New Contract Screen 400 as shown in FIG. 4 is displayed. Here a new contract type 401 is selected from a user defined list of contract types (Not Shown). A Contract Name 402 defaults to the Contract Type but can be customized. The Contract can be associated to the business entity responsible for performing the work, namely a Store 403. A Primary Employee 404 is selected and listed on all customer invoices associated with this maintenance contract as the primary salesperson. The Employee selected in a Notify Employee 405 will be notified when the end of the contract period is approaching. When a Contract is first created it has a Status of Open and a sub Status of Draft 406. Once all information is entered or selected, a user of the program 104 (FIG. 1) clicks on Save New Contract 407.

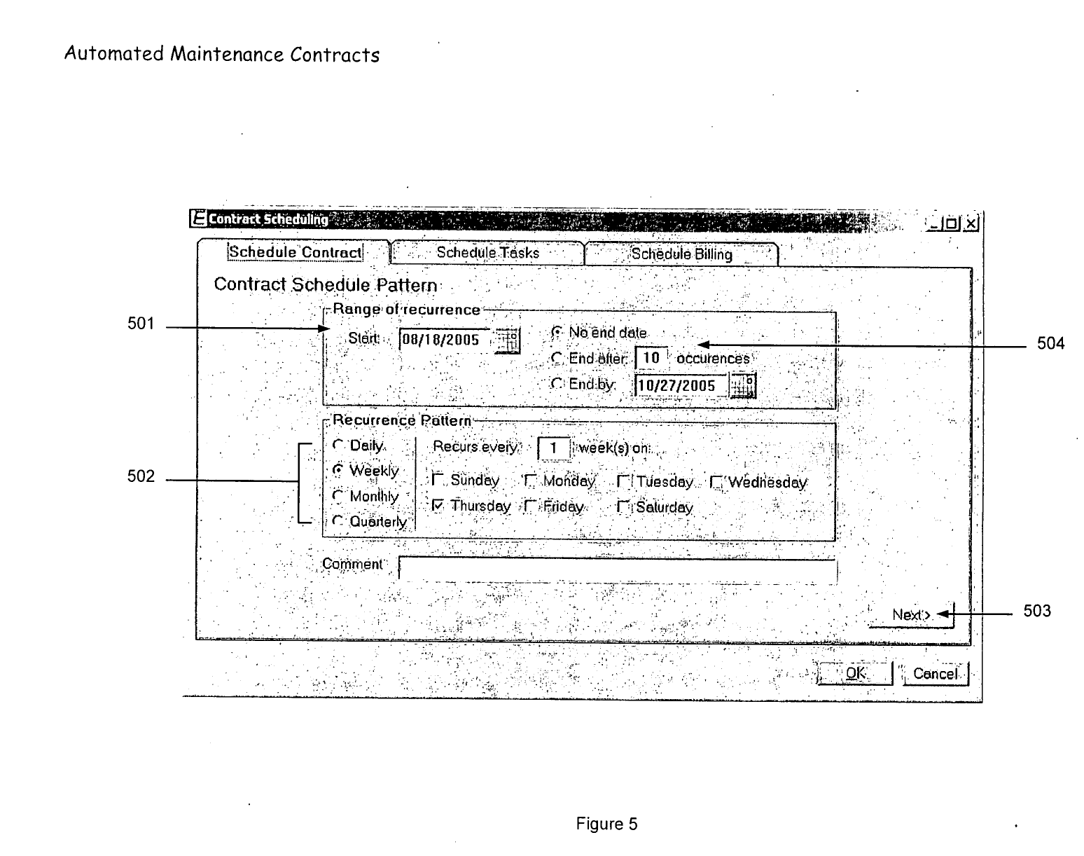

The details of the contract need to be defined by using a Contract Scheduling Screen as depicted in FIG. 5. Pertinent information on the maintenance contract such as a start date 501 needs to be entered in the upper left portion of the Contract Scheduling screen 500. Several options 504 are available for termination of the contract such as after a certain number of occurrences, on a specific date, or no end date. Recurrence patterns can be established for daily, weekly, monthly, or quarterly by selecting radial buttons 502. Once all information is entered or selected, a user of the program clicks on Next 503.

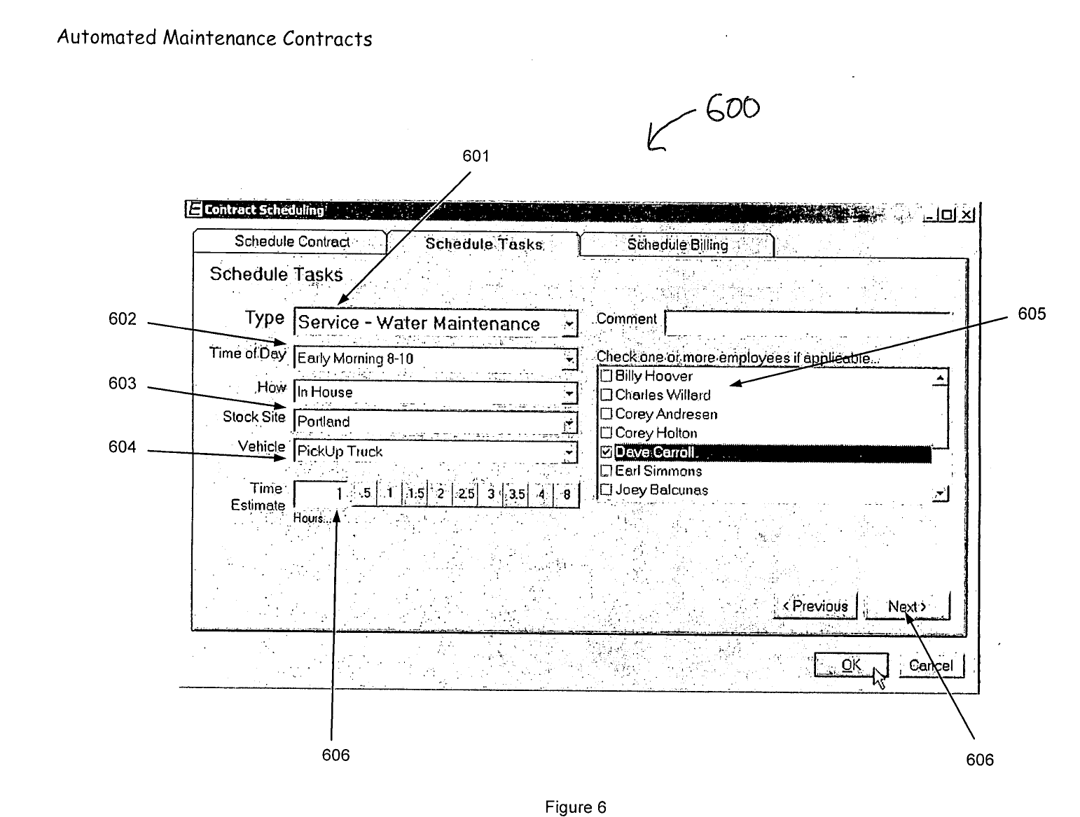

The maintenance contract component 105 of the program 104 then takes a user to a Contract Scheduling Screen 600 of FIG. 6. Here the services that will be performed on a scheduled basis are defined. The Contract Schedule Tasks can be defined by supplying a Task Type 601, a Time of Day 602, a Stock Site 603, a Service Vehicle involved 604, and an estimated amount 606 of time it will take to perform the work. On the right side of the Contract Scheduling Screen 600, an employee 605 which will be performing the work is selected. Selecting the employee automatically schedules a reoccurring appointment in the employees calendar (Not Shown) for the duration of the contract. When all selections are entered, a user of the program clicks on a Next button 606 to continue.

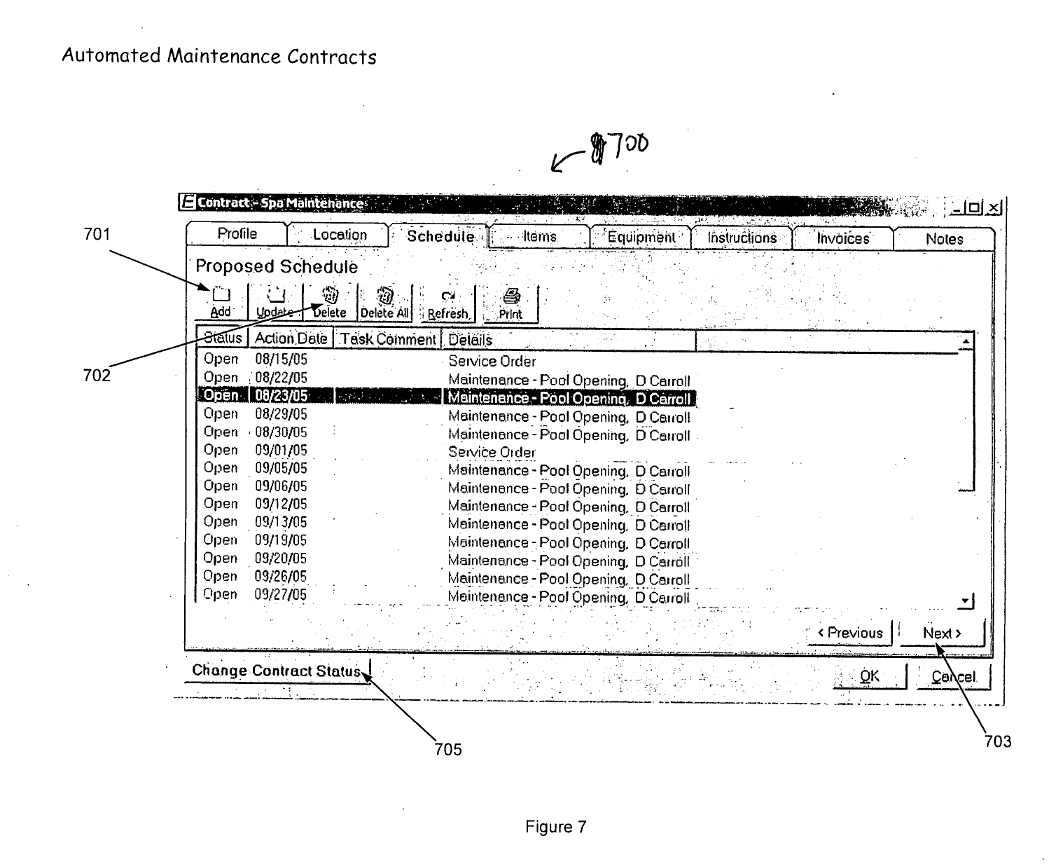

FIG. 7 is a screen 700 showing an overview of items scheduled for a given maintenance contract. The business owner can review the proposed schedule of maintenance tasks. Here tasks can be added 701 or deleted 702 before being posted to the actual schedule of work. Select “Change the Contract Status” 705 to change the contract status. When all selections are entered, a user of the program clicks on the Next button 703 to continue.

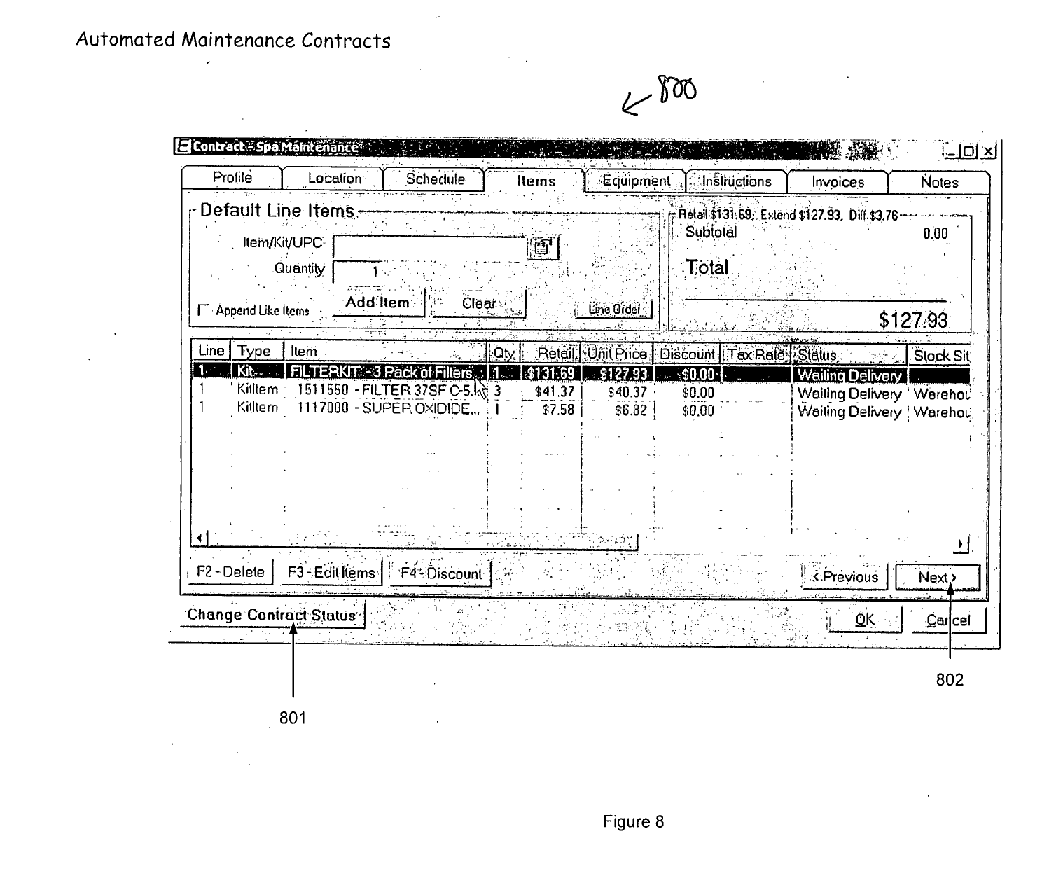

FIG. 8 is a screen 800 showing a list of the Materials used in a recurring way for the maintenance jobs that are associated with the contract. These lists of materials are automatically added to a work order by the program 104. Adding line items to the contract allows an employee to always have all appropriate materials to complete the assigned task created by the maintenance contract. This also ensures that all materials used in performance of the contract are properly billed to the customer. Select “Change the Contract Status” 801 to change the contract status. When all selections are entered, a user of the program clicks on the Next button 802 to continue.

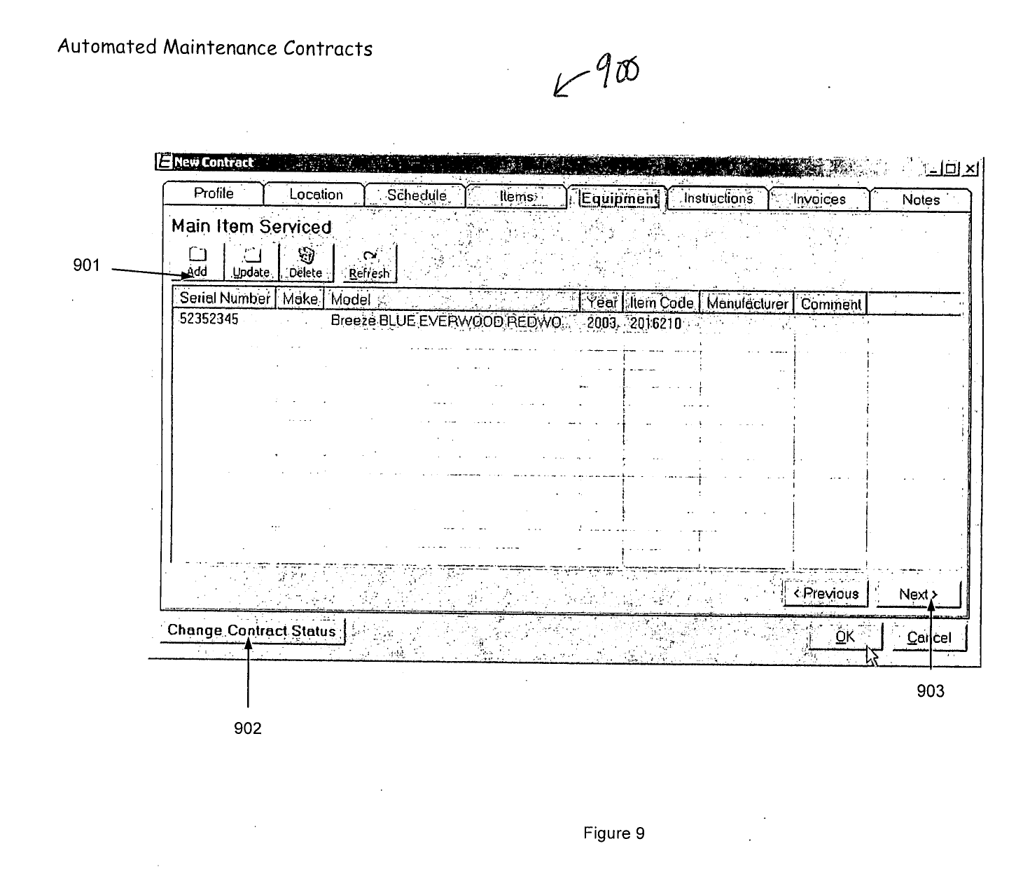

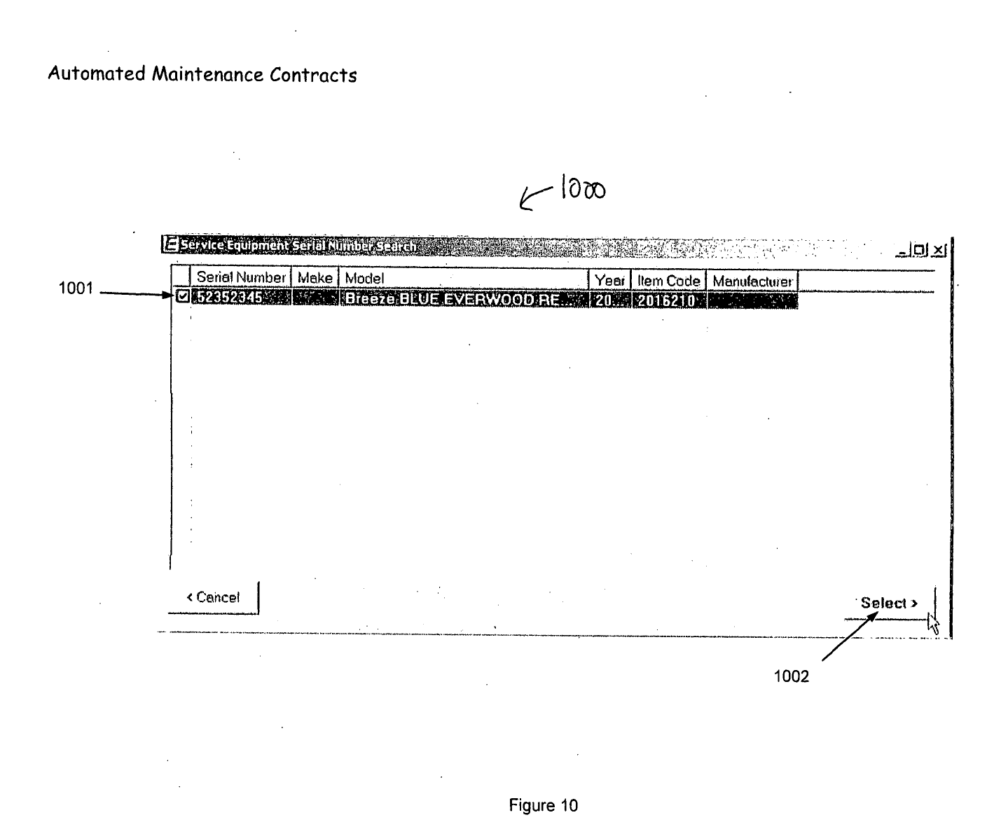

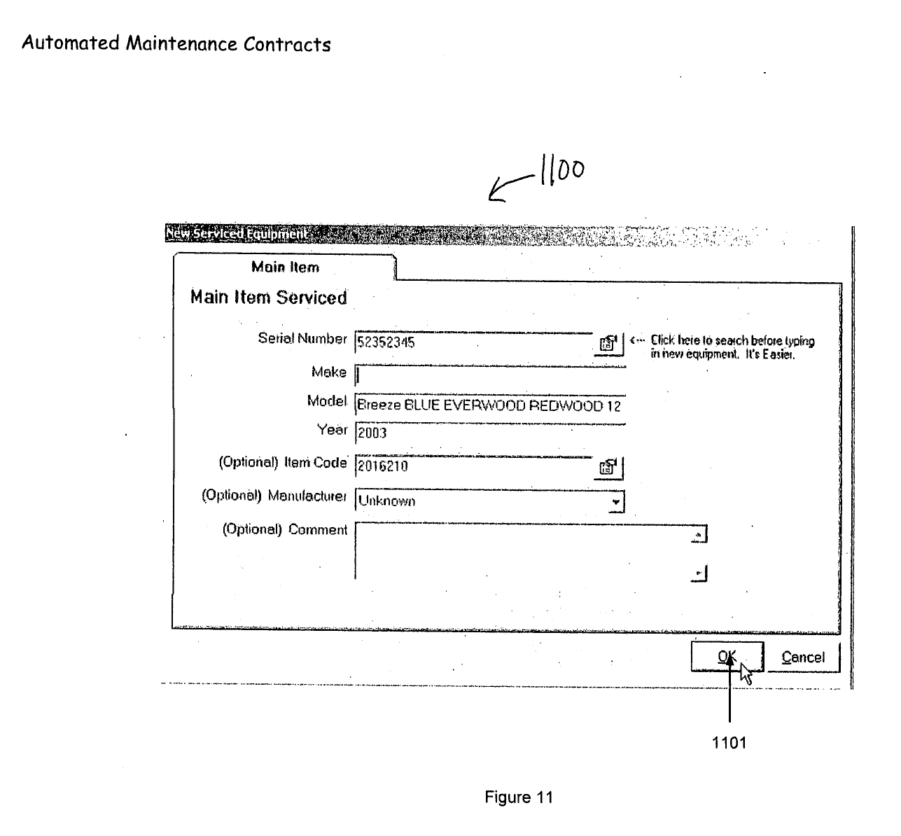

In FIG. 9, through a screen 900 a user of the program 104 can assign the customers equipment that will be serviced for a given maintenance contract. This associates the equipment with the contract. A user of the program clicks on Add 901 to display a list of customer equipment registered in the database (not shown) of the program. Referring to FIG. 10, a user of the program 104 can check through a screen 1000 the equipment to be serviced 1001 and then click on Select 1002. This displays a New Serviced Equipment Screen 1100 as shown in FIG. 11. Here a user of the program 104 may review and modify the equipment details before adding it as Equipment serviced by this maintenance contract. To return to the Equipment to be serviced screen 900 of FIG. 9, a user of the program clicks on the OK button 1101. A user selects “Change the Contract Status” 902 to change the contract status. When all selections are entered, a user of the program 104 clicks on the Next button 903 to continue.

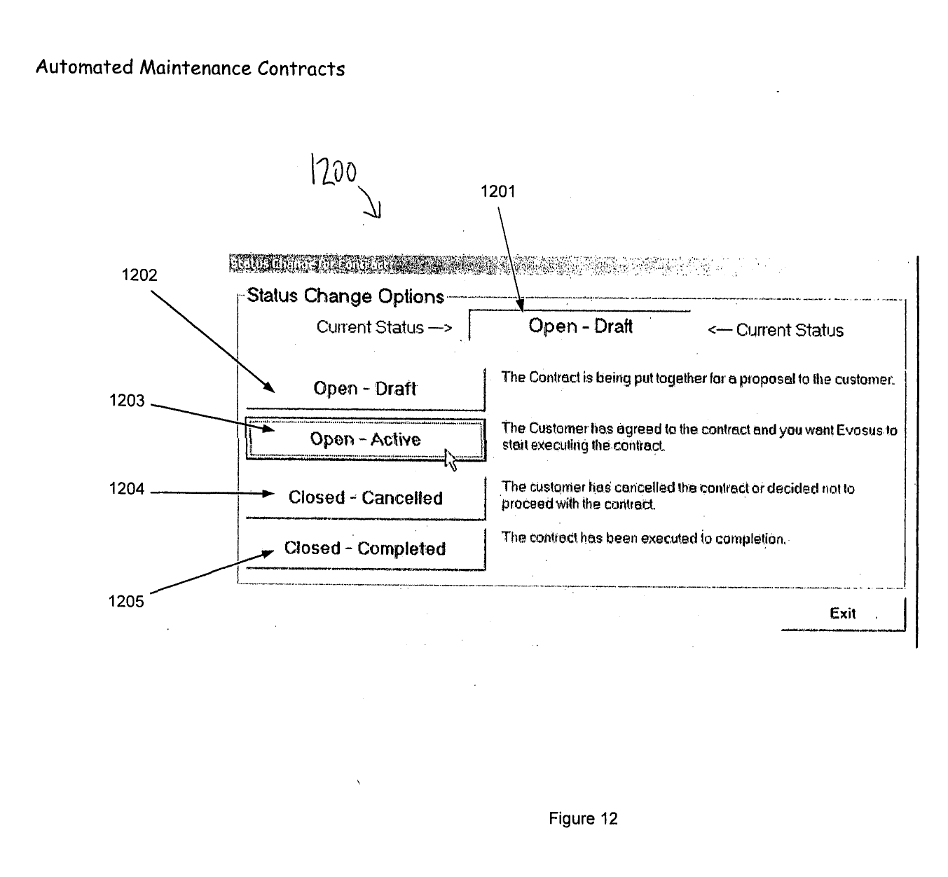

FIG. 12 shows the Maintenance Contract Status Screen 1200. In this screen, a user of the program 104 can change the status of the maintenance contract. The status determines which maintenance contracts appear in lists throughout the program 104 and which contracts are acted upon by a nightly batch job executed by the program. There are four different statuses that a maintenance contract can be in. By selecting the appropriate button, a user of the program 104 can change the status of the maintenance contract. The different statuses are Open-Draft 1202, which is the initial status of a new maintenance contract when it is first created. When a maintenance contract is in this status, no events are automatically scheduled in the program 104. The second status is Open-Active 1203, which is typically the second status given to a contract. Contracts in this status are acted upon by the nightly batch job. The third status is Closed-Cancelled 1204, which is used when a maintenance contract is cancelled by the customer. The nightly batch job no longer acts on contracts in this status. The fourth status is Closed- Completed 1205, and this is the status automatically given to a contract after the end date of the contract has past. The current status of the Maintenance Contract is shown in a current status window 1201.

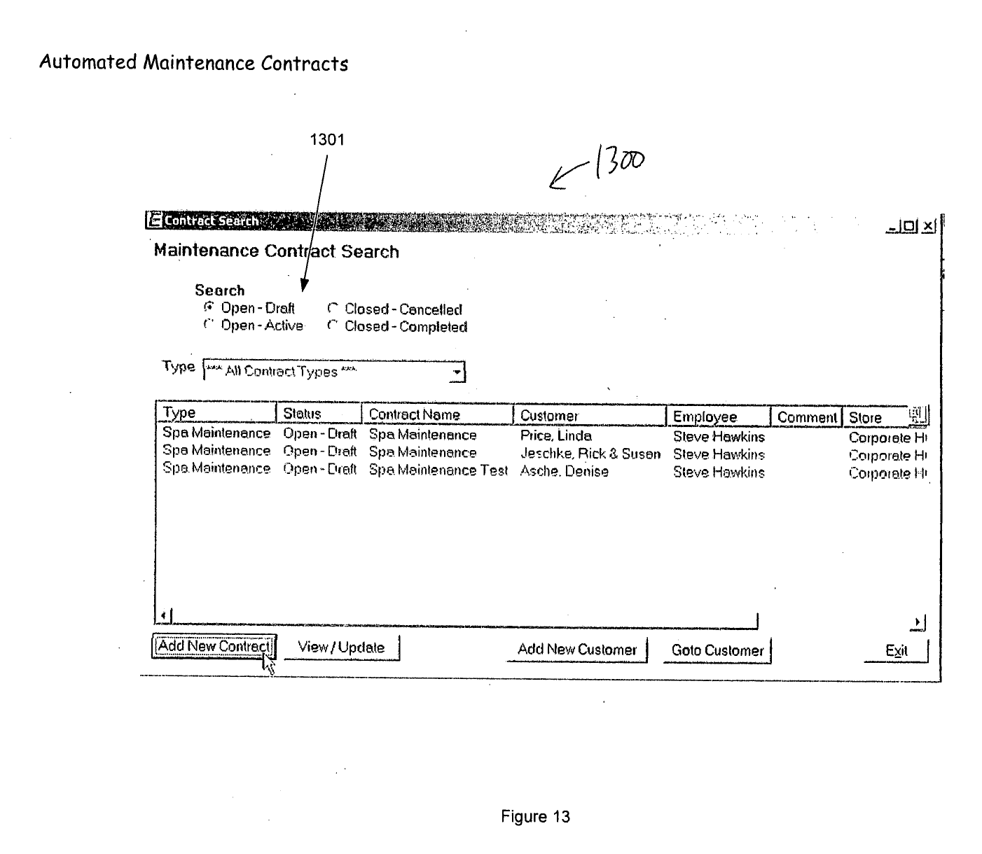

FIG. 13 shows a maintenance Contract Search Screen 1300 which shows all maintenance contracts currently entered in the program 104. A user of the program 104 can filter their search of the contracts by using search radial buttons 1301.

Even though various embodiments and advantages of the present invention have been set forth in the foregoing description, the above disclosure is illustrative only, and changes may be made in detail and yet remain within the broad principles of the present invention. Therefore, the present invention is to be limited only by the appended claims.

What is claimed is:

1. A method of tracking aspects of reoccurring maintenance contracts, comprising:
defining contract parameters including,
customer information,
contract type,
work location,
equipment to be serviced,
work to be performed,
duration of the maintenance contract,
days to perform work,
frequency of service to be performed,
personnel and/or vehicle required to perform the work, and
materials and labor required to perform the work; and
tracking work performed over a given period of time; and
from the above parameters and the operation of tracking, generating a corresponding invoice for a customer.

2. The method of claim 1 wherein the invoice is generated monthly.
